(19) United States
(12) Patent Application Publication
(10) Pub. No.: US 2012/0306109 A1
(43) Pub. Date: Dec. 6, 2012

(54) Method For Evenly Preparing Filament By Using High-Shearing Solution of Ultrahigh-Molecular-Weight Polyethylene

(75) Inventors: ChenSi Chen, Zhejiang (CN); Shi An Xu, Zhejiang (CN); Guanjun Chen, Zhejiang (CN)

(73) Assignee: NINGBO DACHENG ADVANCED MATERIAL CO., LTD., Zhejiang (CN)

(21) Appl. No.: 13/143,972

(22) PCT Filed: Nov. 8, 2010
(86) PCT No.: PCT/CN2010/075868

§ 371 Date: Aug. 6, 2012

(30) Foreign Application Priority Data
Nov. 26, 2009 (CN) 200910224216

(51) Int. Cl. B29B 9/12

(52) U.S. Cl. 264/12; 264/13

(57) ABSTRACT

A method for evenly preparing filament by using high-shearing solution of ultrahigh-molecular-weight polyethylene is disclosed. The method involves mixing an ultrahigh-molecular-weight polyethylene with a solvent in a predetermined ratio, and processing the mixture through a high-shear method to prepare an ultrahigh-molecular-weight polyethylene emulsion solution that is extruded by a dual-screw extruder and quenched in chilled water into a gel protofilament. The gel protofilament is then cleaned by a hydrocarbon cleaning agent before undergoing extraction drawing, drying and hot drawing multiple times so as to form high-tenacity, high-modulus polyethylene fiber. The resultant fiber has good mechanical properties and less fiber misalignment while its production enjoys advantages of low energy consumption, good production conditions, and short production cycle.

### BACKGROUND OF THE INVENTION

1. Technical Field

The present invention relates to a two-step method for evenly preparing filament by using a high-shearing solution of ultrahigh-molecular-weight polyethylene.

2. Description of Related Art

Recently, a lot of attention has been paid to research on production of ultrahigh-tenacity, high-modulus fiber made from ultrahigh-molecular-weight polyethylene. Conventionally, the fiber of interest is made through a two-step process. The first step involves intermittent swelling, where high-temperature swelling of ultrahigh-molecular-weight polyethylene is performed in a tank with the presence of a solvent (typically by heating at 90-120° C. for 30-90 minutes). In the second step, the material is extruded from a dual-screw extruder and quenched as gel filaments to be taken up into rolls. The gel filaments are then extracted by using an extracting agent such as gasoline, carbon tetroxide, xylene or dichloromethane and undergo drying and ultra-drawing procedures so as to form the desired ultrahigh-tenacity, high-modulus fiber.

Currently, many methods have been used to prepare filaments and some of them are described below:

China Patent No. ZL85107352 has proposed a “method for continuously preparing uniform solution of high-molecular-weight polymer”, which produces a suspension where fine high-molecular-weight polymer particles are suspended in a suitable solvent. In particular, at a certain temperature, the high-molecular-weight polymer passes through a direct-rotational dual-screw extruder that is equipped with alternately arranged mixing units and conveying units, so as to form a solution of the high-molecular-weight polymer. In the above process, the processing conditions include heating temperature of 90° C.-220° C., heating time of 30-40 minutes, and screw's rotation speed of 150-300 rpm. As well known, the high-molecular-weight polyethylene typically has a melting point as low as about 136° C. Holding the solution at such a high temperature for 30-40 minutes can cause serious molecular weight degradation and molecular weight separation to the processed polyethylene, leading to low fiber tenacity and high energy consumption during production.

U.S. Pat. No. 4,413,110 granted to Allied Corporation pre-dissolves an ultrahigh-molecular-weight polyethylene in paraffin oil and further dissolves it with a double helical mixer for making a paste that is delivered to a dual-screw extruder to have the polyethylene fully dissolved. In the above process, the pre-dissolving step is intended to shorten the duration where the paste stays in the dual-screw extruder. However, the pre-dissolving step may incur thermal oxidative degradation of the polyethylene, and requires a complicated mechanical system employing a high-temperature high-pressure double helical mixer that is difficult to make. Another US Patent granted to Allied-Signal Inc., U.S. Pat. No. 4,784,820, has proposed a further developed process, wherein a paste made by pre-dissolving an ultrahigh-molecular-weight polyethylene in paraffin oil is introduced into a high-speed mixing drum (1725 rpm) that uniformizes the paste, and then the paste is finally mixed in a single-screw system under a certain pressure, so as to obtain a polyethylene filament solution. The above process, however, brings about safety concerns and the produced polyethylene filament solution is less uniform. In addition, since the pressure and rotation rate of the screw are known to be key factors that dominate filament stability, the low screw pressure in the process can adversely affect filament stability.

China Patent No. ZL97106768.6 allows an ultrahigh-molecular-weight polyethylene to appropriately swell in a solvent so as to form a suspension. The suspension is continuously and constantly fed into a dual-screw extruder at atmospheric pressure followed by the sequent process of swelling, dissolving, bubble eliminating, measuring and outputting, so as to prepare a uniform filament solution. The above process involves intermittent procedures that lengthen the overall process. First, the high-molecular-weight polyethylene and the solvent have to be mixed in a reaction tank, the mixture is heated to 90° C.-120° C., then held for ten minutes to one hour so that the polyethylene can swell and the suspension can be obtained. The post-swelling suspension is then delivered to another reaction tank for cooling before being continuously fed into the dual-screw extruder to produce the filament. The prior-art process involves intermittent procedures in different tanks. Since it is difficult in manufacture to ensure constant concentration, temperature and particle size of the suspension between the tanks, the product tends to have inconstant properties and the overall process is complicated.

China Patent Application No. 200810034215 has disclosed a filament process for high-tenacity, high-modulus ultrahigh-molecular-weight polyethylene fiber. The process adopts a single-step method to continuously accomplish swelling and dissolving. This single-step method nevertheless has its defect. That is, the relatively high swelling temperature can increase degradation of the high-molecular-weight polymer during swelling, thereby giving the resulting fiber poor mechanical properties.

China Patent No. ZL90102855.X relates to a method for preparing high-tenacity, high-modulus polyethylene fiber. In this method, a ultrahigh-molecular-weight polyethylene is dissolved in a coal oil solvent to form a semi-dilute solution that is later extruded by a dual-screw filament system and quenched in a refrigerant (known as “supercooled dry-jet-wet filament”) to form a gel fiber. The coal oil is extracted from the gel fiber by using a gasoline solvent and then the fiber is dried to receive ultra drawing. This process, similar to the foregoing prior-art process contained in China Patent No. ZL97106768.6, uses an intermittently heating and swelling process between tanks, to dissolve the ultrahigh-molecular-weight polyethylene in the coal oil solvent so as to form a semi-dilute solution. Hence, it also has the effect of prior-art China Patent No. ZL97106768.6. That is, constant concentration, temperature and particle size of the semi-dilute solution between the tanks are difficult to achieve, so the polymer tends to have thermal oxidative degradation, which affects the mechanical properties of the resultant fiber. In addition, the solvent used in the method is coal oil, which is likely to evaporate and is flammable. Through long-term heating and mixing operation, evaporated coal oil may mix with air to form an explosive gas mixture that seriously threatens manufacture safety. Moreover, coal oil has an unpleasant odor that pollutes the air and is harmful to operators' health.

China Patent No. ZL03106030.7 has disclosed a method for making high-tenacity polyethylene fiber. The method includes: dissolving a polymer mixture composed of 99 parts by weight to 50 parts by weight of an ethylene-based high-molecular-weight polymer (A) that has an intrinsic viscosity [η] above 5 and an Mw/Mn ratio less than 4 and 1 part by weight to 50 parts by weight of an ultrahigh-molecular-weight polymer (B) that has an intrinsic viscosity equal to more than 1.2 time of the intrinsic viscosity of the high-molecular-weight polymer (A), so as to achieve a concentration between 5 wt % and 80 wt % for later filament and drawing.

China Patent Nos. ZL85107352 and ZL97106768.6 as well as U.S. Pat. No. 4,413,110 all involve a pre-dissolving or pre-swelling step, and use screws to contribute further dissolution so as to prepare their ultrahigh-molecular-weight polyethylene solutions. These processes are actually intermittent, so the overall preparation suffers from low production efficiency, high energy consumption, complicated equipment and long production cycle. Moreover, during preparation, thermal oxidative degradation of ultrahigh-molecular-weight polyethylene is almost unavoidable, and the solutions made through these methods are less uniform.

To sum up, the conventional two-step method has some defects. First, in the course of mixing the ultrahigh-molecular-weight polyethylene with the solvent for swelling, the high swelling temperature and long swelling time can make thermal oxidative degradation happen to the ultrahigh-molecular-weight polyethylene, which adversely affects the resultant fiber's mechanical properties. Second, the intermittent swelling is performed in multiple swelling tanks, and the reaction temperature, solution concentration, and polyethylene particle size in different tanks are different, which directly causes significant differences in the properties of the fiber produced in subsequent processes. Also, the post-swelling solution is sent to the dual-screw extruder from the swelling tank by means of a vacuum pump to be extruded and quenched to form gel filaments to be rolled up. Due to the differences in solution concentration, particle size, and temperature between tanks, the as-spun gel filaments may shrink unevenly. Furthermore, after the unevenly shrinking as-spun gel fiber from the previous step undergoes the extraction step where gasoline, carbon tetroxide, xylene or dichloromethane is used as an extracting agent, the drying step and the ultra drawing step, the resultant fiber tends to have filament fuzzing and filament collaring, undesirably presenting poor mechanical properties and less unconformity. Moreover, since the extracting agent is flammable and an explosive liquid, and tends to evaporate, the conventional method performed under poor production conditions has great safety concerns during the extraction, and consumes more energy.

### SUMMARY OF THE INVENTION

Preparation of a uniform filament solution of ultrahigh-molecular-weight polyethylene is critical to production of polyethylene-based gel filaments, which determines the ability to produce ultrahigh-molecular-weight polyethylene filament and the uniformity as well as the mechanical properties of the resultant fiber, while contributing to the purposes of saving energy and reducing consumption. The present invention uses high shear to grind an ultrahigh-molecular-weight polyethylene and mix it with a solvent at atmospheric temperature so as to obtain a uniform filament solution. The method performed at the atmospheric temperature helps to prevent the ultrahigh-molecular-weight polyethylene form oxidation and degradation, and satisfies requirements of ultrahigh-molecular-weight polyethylene fiber products of various specifications while being suitable to processes where a high drawing rate is desired. It also helps to significantly reduce filament collaring, filament breaking, filament fuzzing and uniform filament caused by poor solution uniformity, thereby stabilizing filament production and significantly improving fiber's mechanical properties.

In view of the shortcomings of the existing techniques, the present invention provides a method for evenly preparing filament by using high-shearing solution of ultrahigh-molecular-weight polyethylene. By implementing the disclosed method, the problems of the prior-art preparation processes can be generally solved. In addition, the method of the present invention requires only a relatively short processing time and can almost completely prevent the ultrahigh-molecular-weight polyethylene from degradation.

The present invention provides a method for evenly preparing filament by using high-shearing solution of ultrahigh-molecular-weight polyethylene that comprises selecting a suitable solvent and an ultrahigh-molecular-weight polyethylene, continuously feeding the solvent and the high-molecular-weight polyethylene measured by an automatic metering means to a mixer in a predetermined ratio at the atmospheric temperature according to processing requirements so as to obtain a uniform suspension that is guided to a high-shearing pump, operating the high-shearing pump at high speed so as to grind the ultrahigh-molecular-weight polyethylene circulating in the solvent at the high speed and obtain a uniform, emulsion-like filament solution, and continuously providing the uniform, emulsion-like filament solution to a dual-screw extruder to form a filament.

The above steps are performed successively in an automatic metering manner such that the solution has constant and matching output and input flows. The high-shearing pump has a compact inner structure so as to allow the ultrahigh-molecular-weight polyethylene to be evenly dissolved in the solvent under high-speed grinding. Although the high-shearing pump operates at high speed, all the steps are performed at the atmospheric temperature. In addition, the solvent acts as a refrigerant inside the high-shearing pump, while a cooling device is provided outside. Thus, the solution is not likely to be heated during high-speed grinding. Since the grinding is completed in a very short term and the entire step involves no heating, degradation or molecular separation of the ultrahigh-molecular-weight polyethylene caused by high temperature is unlikely to happen throughout the production.

The disclosed method helps to achieve high uniformity and emulsification of the ultrahigh-molecular-weight polyethylene solution, which can be used to prepare either a low-concentration or a high concentration high-molecular-weight polyethylene solution. Additionally, as the process is performed at atmospheric temperature without the need of heating, energy consumption can be significantly reduced. The high-shearing pump and the dual-screw extruder are connected through the duct, so multiple high-shearing pumps may be connected in series or in parallel for simultaneous operation according to practical needs, thereby maximizing production efficiency and minimizing production costs. The method of the present invention is a novel method that is completely differently from the existing techniques. The highly uniform, emulsified ultrahigh-molecular-weight polyethylene solution made through the disclosed method satisfies requirements of ultrahigh-molecular-weight polyethylene fiber products of various specifications, and helps to significantly reduce filament collaring, filament breaking, filament fuzzing and uniform filament caused by poor solution uniformity, thereby improving the resultant fiber's mechanical properties.

Particularly, the steps of the present invention method are as follows:

Stage One:

1.1 selecting the ultrahigh-molecular-weight polyethylene and selecting the solvent from hydrogenated naphthalene and alkanes;

1.2 measuring and feeding the ultrahigh-molecular-weight polyethylene by the automatic metering means to a mixing tank as the mixer, and simultaneously measuring and feeding the solvent by the automatic metering means to the same mixing tank for continuous mixing the polyethylene and the solvent at the atmospheric temperature into the uniform suspension, wherein the ultrahigh-molecular-weight polyethylene and the solvent are mixed in the ratio being 5-20 wt % said ultrahigh-molecular-weight polyethylene to 80-95 wt % said solvent, and the ratio is subject to modification according to a desired specification of the fiber;

1.3 delivering the mixed suspension through a pipe to the high-shearing pump, and operating the high-shearing pump at the high speed so as to grinding the ultrahigh-molecular-weight polyethylene circulating in the solvent at the high speed and making the suspension become the uniform high-shear ultrahigh-molecular weight emulsion filament solution that is continuously guided through a duct to the dual-screw extruder;

1.4 heating the high-shear ultrahigh-molecular-weight emulsion filament solution in the duct so that the ultrahigh-molecular-weight polyethylene performs swelling, mixing and dissolving processes fully in the dual-screw extruder before being extruded out of a filament nozzle by a screw member, wherein the swelling, mixing and dissolving processes includes: a first process where the polyethylene-based filament emulsion solution is heated to swell, a second process where the screw member heats the emulsion solution again for further mixing and dissolving, and a third process where the screw member holds the emulsion solution at an elevated temperature and delivers the emulsion solution to the filament nozzle in a metered manner;

1.5 extruding the emulsion solution by the dual-screw extruder out of the filament nozzle to produce an ultrahigh-molecular-weight as-spun filament that is immediately directed to pass through a chilled water to be quenched into a gel protofilament;

1.6 pre-drawing the gel filament, drawing the gel filament through extraction, wherein the extraction is achieved by a close reverse drawing process that uses an environmentally-friendly hydrocarbon cleaning agent as an extracting agent, and pre-drawing the gel filament for a second time by a dry drawing operation at the atmospheric temperature, which is different from the extraction; and

1.7 drying and rolling up the gel filament as multifilament.

Following the foregoing Stage one (first unit) of the two-step filament method of the present invention is Stage two (second unit):

2.1 preheating the multifilament made from the stage one and drawing the multifilament three times under hot air to form fiber; and

2.2 treating the fiber with a thermal setting process, a surface treating process and a natural cooling process so that the cooled fiber is rolled up as a final product.

The present invention thus provides a two-step filament method that allows uniform swelling of ultrahigh-molecular-weight polyethylene under high shear. The resultant fiber has good fiber mechanical properties and less fiber misalignment while its production enjoys advantages of low energy consumption, good production conditions, and short production cycle.

### DETAILED DESCRIPTION OF THE INVENTION

An embodiment is described for further illustrating the present invention.

The present invention method has the following particular steps:

Stage One:

1.1 selecting an ultrahigh-molecular-weight polyethylene having a molecular weight of 1-5 million and selecting a solvent from hydrogenated naphthalene and alkanes, such as paraffin oil, 1,2,3,4-tetrahydronaphthalene or white mineral oil (with a viscosity of 5-80#);

1.2 measuring and feeding the ultrahigh-molecular-weight polyethylene by an automatic metering means to a mixing tank and simultaneously measuring and feeding the solvent by the automatic metering means to the same mixing tank for continuous mixing the polyethylene and the solvent at the atmospheric temperature into the uniform suspension, wherein the ultrahigh-molecular-weight polyethylene and the solvent are mixed in the ratio being 5-20 wt % said ultrahigh-molecular-weight polyethylene to 80-95% said solvent, and the ratio is subject to modification according to a desired specification of the resultant fiber;

1.3 delivering the mixed suspension through a pipe to the high-shearing pump, and operating the high-shearing pump at the high speed so as to grinding the ultrahigh-molecular-weight polyethylene circulating in the solvent at the high speed and making the suspension become the uniform high-shear ultrahigh-molecular weight emulsion filament solution that is continuously guided through a duct to the dual-screw extruder, wherein the high-shearing pump has a capacity adjusted between 10 m³/h and 500 m³/h according to the processing requirements;

1.4 heating the high-shear ultrahigh-molecular-weight emulsion filament solution in the duct so that the ultrahigh-molecular-weight polyethylene performs swelling, mixing and dissolving processes fully in the dual-screw extruder before being extruded out of a filament nozzle by a screw member, screws of the extruder having a length/diameter ratio of 1:50 and an operation speed of 120-300 rpm, wherein the swelling, mixing and dissolving processes includes: a first process where the polyethylene-based filament emulsion solution is heated at a swelling temperature of 70° C.-110° C. to swell (moving forward with the screws), a second process where the screw member heats the emulsion solution again at a temperature of 130° C.-220° C. for further mixing and dissolving (moving forward with the screws), and a third process where the screw member holds the emulsion solution at an elevated temperature of 200° C.-220° C. and delivers the emulsion solution to the filament nozzle in a metered manner;

1.5 extruding the emulsion solution by the dual-screw extruder out of the filament nozzle to produce an ultrahigh-molecular-weight as-spun filament that has a diameter of 1-1.5 mm and is immediately directed to pass through a chilled water of 0° C.-5° C. to be quenched into a gel protofilament (typically referred to as a gel filament) with a linear velocity for quenching of 1-5 meter/minute and a quenching time of 30 seconds to 100 seconds;

1.6 pre-drawing the gel filament to 1-5 times of an initial length thereof, drawing the gel filament through extraction where the gel filament is drawn to 2-8 more times, wherein the extraction is achieved by a close reverse drawing process that uses an environmentally-friendly hydrocarbon cleaning agent such as trichlorotrifluoroethane, trichloroethane or dichloroethane as an extracting agent, wherein the cleaning agent is recyclable with a recovery rate up to 95%, and pre-drawing the gel filament for a second time by a dry drawing operation at the atmospheric temperature, which is different from the extraction; and

1.7 drying and rolling up the gel filament as ultrahigh-molecular-weight polyethylene fiber at a temperature of 40° C.-60° C. for 10-40 minutes.

Following the foregoing Stage one of the two-step filament method of the present invention is Stage two (second unit):

2.1 the multifilament made from the stage one being preheated to 40° C.-60° C. for swelling and held for 20-30 minutes before receiving three continuous times of drawing under hot air, wherein the first time achieves drawing for 2-4 times of a length of the fiber under a circulating hot air at 110° C.-140° C., and the second time achieves drawing for 1.5-2.5 times based on the length of the fiber after the first time of drawing under a circulating hot air at 130° C.-145° C., while the third time achieves drawing for 0.5-1.5 times based on the length of the fiber after the second time of drawing under a circulating hot air at 130 ° C.-165 ° C. so that the ultrahigh-molecular-weight polyethylene has molecular chains thereof fully stretched and molecular crystals arranged uniformly, thereby achieving good mechanical properties and a tenacity >40 g/D;

2.2 treating the fiber with a thermal setting process, a surface treating process and a natural cooling process so that the cooled fiber is rolled up as a final product wherein the thermal setting process is performed at 130° C.-150° C. with a linear velocity of 15-50 meters per minute, and the fiber meantime receives a continuous glow discharge plasma process or a continuous glow discharge plasma process for surface treating.

What is claimed is:

1. A method for evenly preparing filament by using a high-shearing solution of ultrahigh-molecular-weight polyethylene, the method comprising steps of: selecting a suitable solvent and an ultrahigh-molecular-weight polyethylene, continuously feeding the solvent and the high-molecular-weight polyethylene measured by an automatic metering means to a mixer in a predetermined ratio at the atmospheric temperature according to processing requirements so as to obtain a uniform suspension that is then guided to a high-shearing pump, operating the high-shearing pump in a high speed so as to grind the ultrahigh-molecular-weight polyethylene circulating in the solvent at the high speed and obtain a uniform, emulsion-like filament solution, and continuously providing the uniform, emulsion-like filament solution to a dual-screw extruder for filament.

2. The method of claim 1, particularly divided into two stages:
Stage one:
1.1 selecting the ultrahigh-molecular-weight polyethylene and selecting the solvent from hydrogenated naphthalene and alkanes;
1.2 measuring and feeding the ultrahigh-molecular-weight polyethylene by the automatic metering means to a mixing tank as the mixer, and simultaneously measuring and feeding the solvent by the automatic metering means to the same mixing tank for continuous mixing the polyethylene and the solvent at the atmospheric temperature into the uniform suspension;
1.3 delivering the mixed suspension through a pipe to the high-shearing pump, and operating the high-shearing pump at the high speed so as to grinding the ultrahigh-molecular-weight polyethylene circulating in the solvent at the high speed and making the suspension become the uniform high-shear ultrahigh-molecular weight emulsion filament solution that is continuously guided through a duct to the dual-screw extruder;
1.4 heating the high-shear ultrahigh-molecular-weight emulsion filament solution in the duct so that the ultrahigh-molecular-weight polyethylene performs swelling, mixing and dissolving processes fully in the dual-screw extruder before being extruded out of a filament nozzle by a screw member, wherein the swelling, mixing and dissolving processes includes: a first process where the polyethylene-based filament emulsion solution is heated to swell, a second process where the screw member heats the emulsion solution again for further mixing and dissolving, and a third process where the screw member holds the emulsion solution at an elevated temperature and delivers the emulsion solution to the filament nozzle in a metered manner;
1.5 extruding the emulsion solution by the dual-screw extruder out of the filament nozzle to produce an ultrahigh-molecular-weight as-spun filament that is immediately directed to pass through a chilled water to be quenched into a gel protofilament;
1.6 pre-drawing the gel filament, drawing the gel filament through extraction, wherein the extraction is achieved by a close reverse drawing process that uses an environmentally-friendly hydrocarbon cleaning agent as an extracting agent, and pre-drawing the gel filament for a second time by a dry drawing operation at the atmospheric temperature, which is different from the extraction; and
1.7 drying and rolling up the gel filament as multifilament; and
Stage two:
2.1 preheating the multifilament made from the stage one and drawing the multifilament three times under hot air to form fiber; and
2.2 treating the fiber with a thermal setting process, a surface treating process and a natural cooling process so that the cooled fiber is rolled up as a final product.

3. The method of claim 2, further comprising:
in the step 1.1, the solvent being paraffin oil, 1,2,3,4-tetrahydronaphthalene or a white mineral oil;
in the step 1.2, the predetermined ratio for mixing being 5-20% said ultrahigh-molecular-weight polyethylene to 80-95% said solvent, and being subject to modification according to a desired specification of the fiber;
in the step 1.3, the high-shearing pump having a capacity of 10 m3/h-500 m3/h;
in the step 1.4, screws of the extruder having a length/diameter ratio of 1:50 and an operation speed of 120-300 rpm, the first process where the polyethylene-based filament emulsion solution is heated to swell being performed at a temperature of 70° C.-110° C., the second process for mixing and dissolving being performed at a temperature of 130° C.-220° C., and the third process for holding and delivering being performed at a temperature of 200° C.-220° C.;
in the step 1.5, the as-spun filament having a diameter of 1-1.5 mm and passing through the chilled water of 0° C.-5° C. to be quenched into the gel protofilament (typically referred to as a gel filament) with a linear velocity for quenching of 1-5 meter/minute and a quenching time of 30-100 seconds;
in the step 1.6, the gel filament being pre-drawn to 1-5 times of an initial length thereof before the extraction where the gel filament is drawn to 2-8 more times, wherein the extraction is achieved by the close reverse drawing process that uses the environmentally-friendly hydrocarbon cleaning agent as the extracting agent, and the cleaning agent is trichlorotrifluoroethane, trichloroethane or dichloroethane; and
in the step 1.7, the drying and rolling up the gel filament being performed at a temperature of 40° C.-60° C. for 10-40 minutes.

4. The method of claim 2, further comprising:
in the step 2.1, the multifilament made from the stage one being preheated to 40° C.-60° C. for swelling and held for 20-30 minutes before receiving the three times of drawing under hat air, wherein the first time achieves drawing for 2-4 times of a length of the fiber under a circulating hot air at 110° C.-140° C., and the second time achieves drawing for 1.5-2.5 times based on the length of the fiber after the first time of drawing under a circulating hot air at 130° C.-145° C., while the third time achieves drawing for 0.5-1.5 times based on the length of the fiber after the second time of drawing under a circulating hot air at 130° C.-165° C. so that the ultrahigh-molecular-weight polyethylene has molecular chains thereof fully stretched and molecular crystals thereof arranged uniformly;
in the step 2.2, the thermal setting process is performed at 130° C.-150° C. with a linear velocity of 15-50 meters per minute.

5. The method of claim 4, wherein in the step 2.2, the fiber during the thermal-setting, surface treating and natural cooling processes receives a continuous glow discharge plasma process or a continuous glow discharge plasma process for surface treating.
